(19) United States
(12) Patent Application Publication
(10) Pub. No.: US 2016/0327083 A1
(43) Pub. Date: Nov. 10, 2016

(54) QUICK RELEASE FASTENER

(71) Applicant: Hsi-Tong Lin, Changhua County (TW)

(72) Inventor: Hsi-Tong Lin, Changhua County (TW)

(21) Appl. No.: 14/703,894

(22) Filed: May 5, 2015

(51) Int. Cl. F16B 39/02; F16B 43/00

(52) U.S. Cl. CPC F16B 39/02; F16B 43/00

(57) ABSTRACT

The invention includes a threaded rod, a head, a pressing washer and a rotator. The head is firmly connected on an end of the threaded rod and is a hollow cylinder with a central hole. An axis of the head is perpendicular to that of the threaded rod. The pressing washer is passed through by the threaded rod and placed under the head. The rotator is a U-shaped body with two symmetrical and parallel cams and a recess therebetween. Each of the two cams has a pivot hole. The head is embedded in the recess, and a pivot is inserted into the two pivot holes and the central hole. The two cams progressively press or release the pressing washer while the rotator is being rotated about the pivot.

### BACKGROUND OF THE INVENTION

1. Technical Field

The invention relates to bolts, particularly to quick release bolts.

2. Related Art

A conventional bolt 20, as shown in FIGS. 1-3, includes a head 21, a threaded rod 24 and a pressing portion 25. The bottom of the head 21 is formed with a conic surface 23 which inclines outwards and forms an acute-angled edge 231. The pressing portion 25 surrounds the threaded rod 24 and abuts against the conic surface 23. The pressing portion 25 and the acute angled edge 231 are coplanar on plane L. A conic space 26 is formed in the conic surface 23. When a workpiece 30 is fastened onto a substrate 32, the connection between the head 21 and the workpiece 30 is annular but not planar. This can improve fastening strength of bolt.

However, the bolt 20 must be progressively rotated to finish fastening. It may spend much time and labor. There is no easy and fast solution in the market.

### SUMMARY OF THE INVENTION

An object of the invention is to provide a quick release fastener, which can quickly fasten or release something to be fastened.

To accomplish the above object, the quick release fastener of the invention includes a threaded rod, a head, a pressing washer and a rotator. The head is firmly connected on an end of the threaded rod and is a hollow cylinder with a central hole. An axis of the head is perpendicular to that of the threaded rod. The pressing washer is passed through by the threaded rod and placed under the head. The rotator is a U-shaped body with two symmetrical and parallel cams and a recess therebetween. Each of the two cams has a pivot hole. The head is embedded in the recess, and a pivot is inserted into the two pivot holes and the central hole. The two cams progressively press or release the pressing washer while the rotator is being rotated about the pivot.

### BRIEF DESCRIPTION OF THE DRAWINGS

FIG. 1 is a front view of a conventional bolt;

FIG. 2 is a cross-sectional view of the conventional bolt;

FIG. 3 is a schematic view of the conventional bolt in use;

FIG. 4 is an exploded view of the invention;

FIG. 5 is an assembled view of the invention;

FIG. 6 is a schematic view of the invention in use; and

FIG. 7 is another schematic view of the invention in use

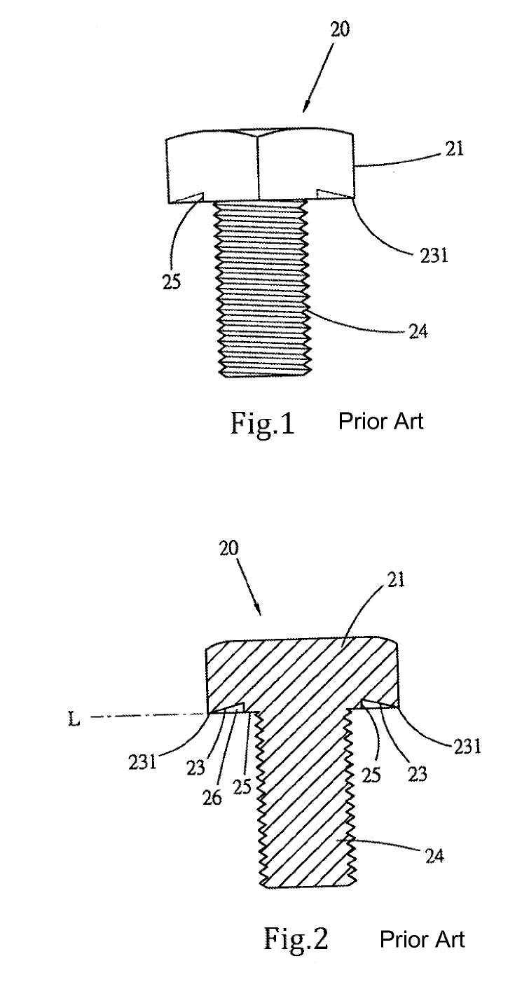

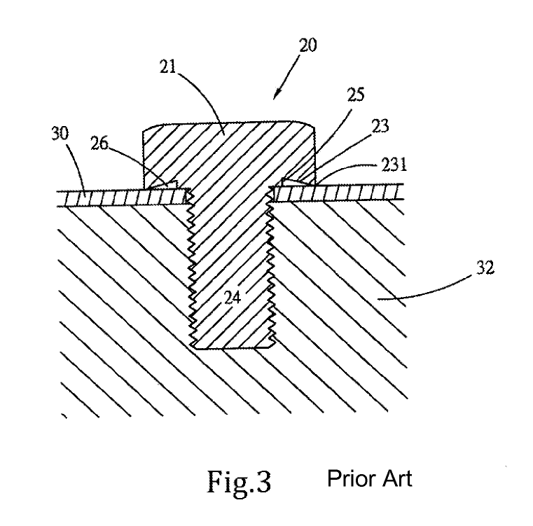

### DETAILED DESCRIPTION OF THE INVENTION

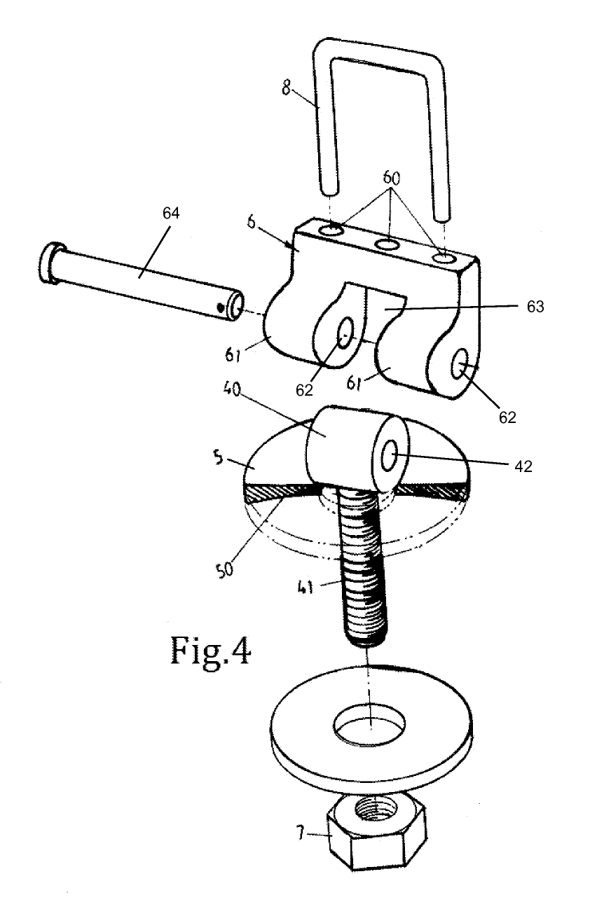

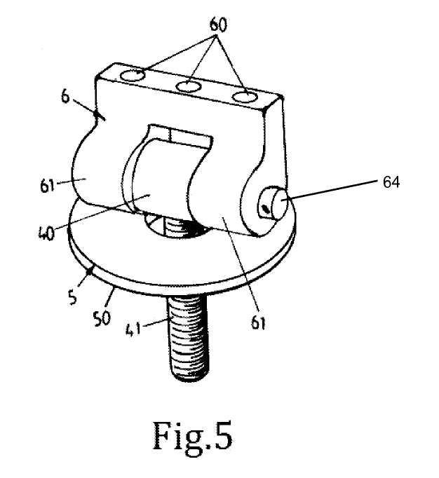

Please refer to FIGS. 4-7. The quick release fastener of the invention includes a threaded rod 41, a head 40, a pressing washer 5 and a rotator 6. The head 40 is firmly connected on an end of the threaded rod 41. The head 40 is a hollow cylinder with a central hole 42. The central hole 42 and the head 40 are coaxial. An axis of the head 40 is perpendicular to that of the threaded rod 41. The pressing washer 5 is an independent annular piece. The pressing washer 5 is passed through by the threaded rod 41 and placed under the head 40. The rotator 6 is a U-shaped body with two symmetrical and parallel cams 61 and a recess 63 therebetween. Each of the two cams 61 has a pivot hole 62. The two pivot holes 62 align with each other.

The recess 63 is substantially identical to the head 40 in shape. Thus the head can be embedded in the recess 63. A pivot 64 is inserted into the two pivot holes 62 and the central hole 42 to make the rotator rotatable. The threaded rod 41 can be rotated by coaxially rotating the rotator 6 without a screw driver.

Preferably, a top surface of the rotator 6 may be provided with one or more inserting holes 60, and a handle 8 is inserted into the inserting holes 60. The handle 8 can help to exert a force to the rotator 6. Furthermore, a lower side 50 of the pressing washer 5 is arc-shaped. A nut 7 can be added to the threaded rod 41.

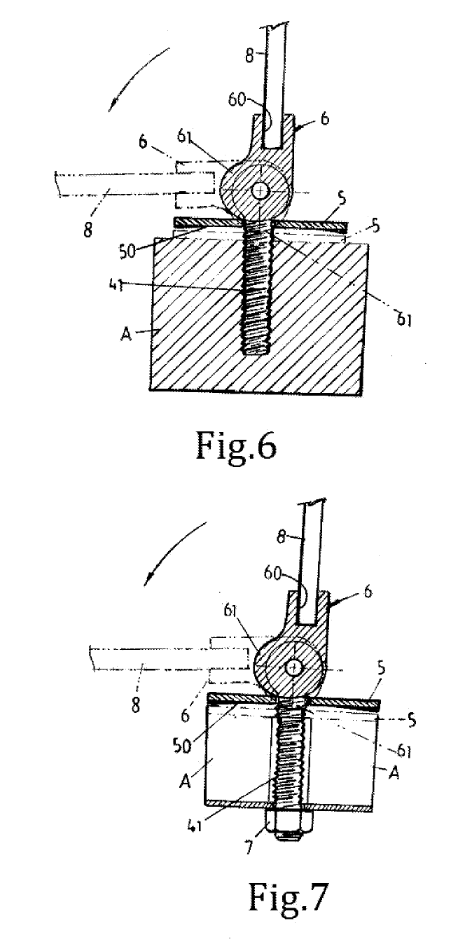

As shown in FIGS. 6 and 7, the threaded rod 41 is used to screw into a workpiece A, the two cams 61 will progressively press or release the pressing washer 5 while the rotator 6 is being rotated about the pivot 64 because of the eccentric effect of the cams 61.

It will be appreciated by persons skilled in the art that the above embodiment has been described by way of example only and not in any limitative sense, and that various alterations and modifications are possible without departure from the scope of the invention as defined by the appended claims.

What is claimed is:

1. A quick release fastener comprising:
a threaded rod;
a head, firmly connected on an end of the threaded rod, and being a hollow cylinder with a central hole, wherein an axis of the head is perpendicular to that of the threaded rod;
a pressing washer, passed through by the threaded rod, and placed under the head; and
a rotator, being a U-shaped body with two symmetrical and parallel cams and a recess therebetween, each of the two cams having a pivot hole, wherein the head is embedded in the recess, and a pivot inserted into the two pivot holes and the central hole;
wherein the two cams progressively press or release the pressing washer while the rotator is being rotated about the pivot.

2. The quick release fastener of claim 1, wherein a top surface of the rotator is provided with an inserting hole, and a handle is inserted into the inserting hole.

3. The quick release fastener of claim 1, wherein a side of the pressing washer is arc-shaped.
